(19) United States
(12) Patent Application Publication
(10) Pub. No.: US 2005/0126355 A1
(43) Pub. Date: Jun. 16, 2005

(54) Device and method for cutting a material web

(76) Inventors: Reiner Schonberger, Grossholbach (DE); Guido Maurer, Neuwied (DE)

Correspondence Address: WILLIAM COLLARD;COLLARD & ROE, P.C., 1077 NORTHERN BOULEVARD, ROSLYN, NY, 11576, US

(21) Appl. No.: 11/007,543

(22) Filed: Dec. 8, 2004

(30) Foreign Application Priority Data
Dec. 10, 2003 (DE) 103 57 795.5

(51) Int. Cl. B26D 1/00

(52) U.S. Cl. 83/13

(57) ABSTRACT

In order to prevent the tracks of ancillary substance from smearing when cutting a material web along predetermined cut progressions that lie between raised tracks of ancillary substance relative to the plane of the material web in the direction of a cutting roller, the web can be cut into segments with a predetermined segment length along the cut progressions by a cutting device. The device has a cutting roller, the angular velocity of which can be adapted to the web velocity for cutting the material web, and which can be accelerated and/or delayed between two consecutive cuts.

### BACKGROUND OF THE INVENTION

1. Field of the Invention

The present invention relates to a device for cutting a material web moving at a web speed into segments, as well as to a method for using the device. The invention can particularly find use in work stations of envelope production machines, in which additional components of the finished envelope are fed to the envelope material web from which the envelopes are produced, or to the envelope cut-outs that have been cut off from the aforementioned material web, such as a transparent window material, for producing envelopes having an address window.

2. The Prior Art

It is known to provide so-called window glue-in stations in envelope production machines. In such stations, a window material web consisting of glassine, for example, has glue applied to it and is subsequently cut into segments or pieces of window material having the desired format, by means of a rotating cutting roller. The window material segments are then placed on the envelope material web that passes through the envelope production machine, or onto the envelope cut-outs that pass through the envelope production machine, in such a manner that they cover the window cut-out that has been made there previously. In this connection, the cutting roller is equipped with a cutting blade that is disposed on its circumference.

In the case of the known window glue-in stations, the cutting roller is configured as a so-called cycled roller. This means that the cutting roller, which has a constant diameter, rotates with the machine cycle, at a constant angular velocity. In this constellation, cutting of the window material web takes place either by means of a synchronous cut or by means of a pulling cut. The ideal case of a synchronous cut exists if the tangential circumference speed of the cutting blade of the cutting roller is equal to the web speed of the window material web. A pulling cut exists if the tangential circumference speed of the cutting blade of the cutting roller is greater than the web speed of the window material web. A cutting situation in which the tangential circumference speed of the cutting blade of the cutting roller is less than the web speed of the window material web should be avoided, since this would result in braking of the window material web during cutting, therefore in a back-up of the material web, and failure of the window glue-in station.

Because of the need for a synchronous or pulling cut, the cutting roller, (or, more precisely, the circular path that is followed by the cutting edge of the cutting blade, the diameter or circumference of which is simply referred to as the diameter or circumference of the cutting roller hereinafter, for the sake of simplicity), must have a minimum diameter. This minimum diameter results from the greatest length of the window material segment to be cut. The development of the circumference of the cutting roller must be at least as long as the maximum segment length to be cut. If this is the case, a precisely synchronous cut occurs when cutting window material segments having the maximum segment length. If shorter window material segments are supposed to be made available, the cutting roller continues to rotate at the same angular velocity, and the web speed is reduced using a pulling roller that precedes the cutting roller. The segment length is thereby determined by the speed of rotation of the cutting roller. The circumference velocity of the cutting blade of the cutting roller is greater, in this case, than the web velocity of the window material web, so that a pulling cut occurs.

Before cutting with the cutting roller, the window material web is provided with a track of glue in a suitable disposition, in known manner. This track of glue ensures that the subsequent window material segments adhere securely to the subsequent envelope, and cover the window cutout that is present there. Cutting of the window material web must take place precisely between two tracks of glue that are disposed relatively closely next to one another. The tracks of glue have a certain spatial expanse in the direction perpendicular to the plane of the window material web, so that the circular path of the cutting edge of the cutting blade of the cutting roller, which must adhere to a minimum diameter, frequently passes through the spatial region taken up by the two tracks of glue that are directly adjacent to one another, between which the planned cut progression lies. The tracks of glue consequently form a barrier that worsens the spatial accessibility of the cut progression for the cutting blade. As a result, the glue smears both on the window material web and on the cut window material segments, and this results in the window material segment sticking to transport devices of the envelope production machine, which can result in failure of the production process.

### SUMMARY OF THE INVENTION

It is therefore an object of the present invention to indicate a possibility for cutting a material web along cut progressions that are difficult to access, which progressions lie between tracks of an ancillary substance, particularly tracks of glue, which are raised relative to the plane of the material web, without smearing the ancillary substance in undesirable manner when cutting the material web.

A device for cutting a material web that moves at a web speed into segments having a predetermined segment length is already known from DE 100 30 055 A1. This known device has a cutting roller, the angular velocity of which can be adapted to the web velocity, for cutting the material web, and which can be accelerated and/or delayed between two consecutive cuts. The adaptation of the angular velocity of the cutting roller to the web velocity can take place in that a synchronous or a pulling cut takes place, similar to the cycled roller.

The method according to the invention uses the device of DE 100 30 055 A1, for cutting the material web along cut progressions that lie between tracks of ancillary substance that are raised, i.e. project relative to the plane of the material web, in the direction of the cutting roller. In this way, the result is advantageously achieved that the diameter of the cutting roller can be significantly reduced, since the cutting roller can be accelerated or delayed to a greater or lesser degree, as a function of the segment length to be cut. It is no longer necessary to adapt the diameter of the cutting roller to the maximum segment length to be cut. Because of the smaller cutting roller diameter, the circular path of the cutting blade of the cutting roller no longer penetrates the tracks of ancillary substance between which the cut progression lies, and which spatially surround the tracks. As a result, no smearing of the tracks of ancillary substance occurs. If necessary, the tracks of ancillary substance can actually be disposed closer to one another, resulting in a saving of window material web, in advantageous manner.

The method according to the invention can be utilized anywhere where a material web must be cut along spatially constricted cut progressions between raised tracks of ancillary substance. This is the case not only in window glue-in stations of envelope production machines, but also, for example, in the separation insert station or the adhesive cover strip station of such machines. Separation inserts are used in envelopes having several chambers, to separate them. Just like the window material, they are glued into the envelopes and cut off from a separation insert material web to which glue has previously been applied. Adhesive cover strips cover the self-adhesive region, for example on a flap of an envelope, and are pulled off by the user before the envelope is sealed. The adhesive cover strips are cut off from an adhesive cover strip material web previously provided with an adhesive, in an adhesive cover strip station.

The method according to the invention results in relatively large acceleration or delay values, and therefore in significant mechanical stress on the cutting roller, its bearings, as well as its drive elements. In order to keep these stresses within reasonable limits, a device for cutting a material web that moves at a web velocity into segments having a predetermined segment length, using a cutting roller, is proposed, the angular velocity of which, for cutting the material web, can be adapted to the web velocity, and which can be accelerated and/or delayed between two consecutive cuts. In the device, at least two or more cutting blades are disposed on the circumference of the cutting roller. In this way, the accelerations and delays of the cutting roller, which are more or less great as a function of the segment length to be cut, can be limited, since a complete rotation of the cutting roller is no longer necessary for the next cutting procedure, in each instance. As a function of the number of cutting blades, the diameter of the cutting roller, and the desired segment length, the acceleration or delay forces that occur can particularly be reduced, in advantageous manner. The disposition of the cutting over the circumference of the cutting roller preferably takes place uniformly, at a constant angular distance.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a cross-section through a window glue-in station of an envelope production machine, to explain the method according to the invention;

FIG. 2 shows a top view of a window material web, to part of which glue has been applied, as well as an individual window material segment, to which glue has been applied; and

FIG. 3 shows a representation, in partial cross-section, of two cutting rollers, which illustrates the reduction in the cutting roller diameter that can be achieved by means of the method according to the invention.

### DETAILED DESCRIPTION OF THE PREFERRED EMBODIMENT

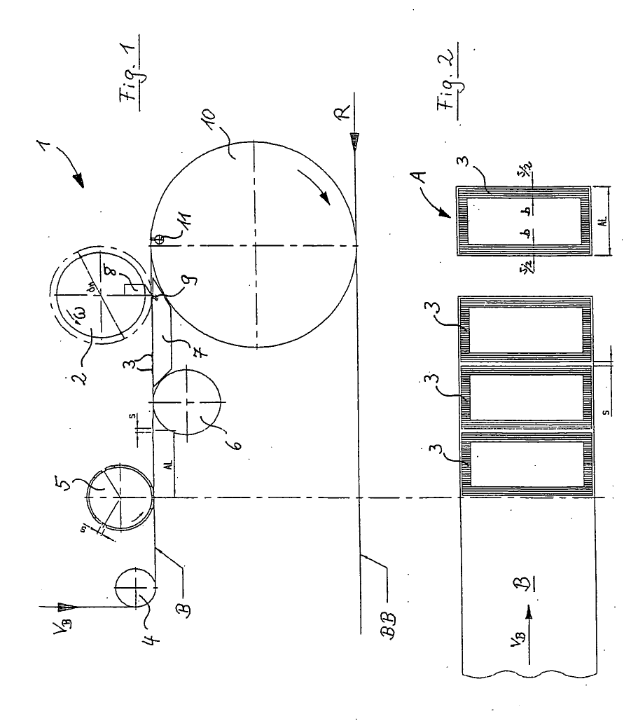

FIG. 1 shows a cross-sectional view through the window glue-in station of an envelope production machine, through which an envelope material web BB or envelope cut-outs, consisting of paper, passes/pass, according to the arrow R, from the right to the left. In the window glue-in station, a window material web B is fed in from a supply roller, not shown, at a web velocity vB, by way of a deflection roller 4 of a glue application roller 5 that rotates counterclockwise, and applies a track 3 of glue in the form of a rectangular ring onto the window material web B, in the embodiment shown, as is best evident in the top view according to FIG. 2. The application of glue takes place in such a manner that two consecutive, rectangular tracks 3 of glue have the spacing s between them as shown in FIGS. 1 and 2. The cut that separates the window material web B into individual segments A must be placed in the region of this spacing s, in each instance.

After glue application by means of the glue application roller 5, the window material web B is transported to a device 1 for cutting the window material web B into segments A, by way of a transport roller 6 that rotates clockwise and a suction transport device 7. The device 1 comprises a cutting roller 2 that can be driven to rotate counterclockwise, at a constant or non-constant angular velocity w. In the embodiment shown, the cutting roller 2 has a single cutting blade 8 on its circumference, which blade interacts with a strip-shaped counter-cutting element 9 for cutting the window material web B. The cutting edge of the cutting blade 8 moves on a circular path having the diameter dM during rotation of the cutting roller 2, as shown in FIG. 1.

After the cutting roller 2 has cut a segment A having the segment length AL off from the window material web B, using the cutting edge of the rotating cutting blade 8, in the region of the spacing s between two consecutive, rectangular tracks 3 of glue, the former is transferred to a suction roller 10, which rotates clockwise. For reasons of a simpler representation in the drawing, only a suction channel 11 of suction roller 10 is shown in FIG. 1. Suction roller 10 guides the cut-off segment A, with the glue applied to it, down on its outer circumference, by an angular distance of 180°, whereby segment A is glued onto the window cut-out that was previously made in envelope material web BB or into the envelope cut-out, in each instance, after it passes through this angular distance. The track 3 of glue serves for this purpose.

Device 1 for cutting the window material web B can be driven, for example, in such a manner as described in DE 100 30 055 A1. This means that the angular velocity w of cutting roller 2 is not constant over an entire rotation of cutting roller 2. Instead, an acceleration or delay of the rotational movement of cutting roller 2 takes place depending on the size of the window in the envelope to be produced, i.e. as a function of the desired segment length AL.

Because of the use of the device known from DE 100 30 055 A1 in the window glue-in station of an envelope production machine, the diameter dM of cutting roller 2 can be minimized. It is not necessary to use a cutting roller having a relatively large diameter, as it was in the case of the window glue-in stations known until now, because of the need for a synchronous or pulling cut.

As indicated in FIG. 1, tracks 3 of glue have a certain spatial expanse perpendicular to the plane of the window material web B (towards the top in FIG. 1). The cutting edge of cutting blade 8 of cutting roller 2 must therefore move over a track of glue at first, in order to cut between two tracks 3 of glue, then perform the cutting procedure in the region of the spacing s, and subsequently move up again, out of the plane of the window material web B, over another track of glue. In this connection, the movement path of the cutting edge of cutting blade 8 should be as steep as possible both when approaching the cut location and when moving away from the cut location, with reference to the plane of window material web B, in order to prevent the movement path of the cutting edge from passing through tracks 3 of glue and thereby taking along and/or scattering glue during this process, so that glue reaches undesirable locations of the window material web B.

Steep movement paths of the cutting edge of cutting blade 8, in this sense, only became possible with the method according to the present invention. The configuration, according to the invention, of a sufficiently steep, i.e. sufficiently strongly curved movement path of the cutting edge of the cutting blade 8 became possible, in the final analysis, by means of a minimization of the diameter dM of the cutting roller 2, independent of the segment length AL.

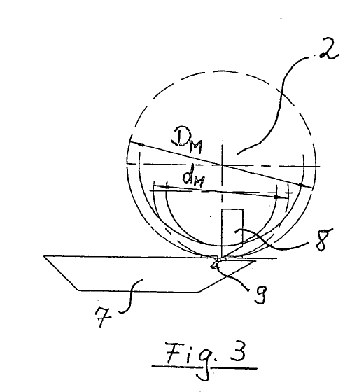

In FIG. 3, the qualitative reduction in the diameter of cutting roller 2, according to the invention, is shown using a cross-sectional drawing. Cutting roller 2 of previous window glue-in stations had the diameter DM. The method according to the invention allows a cutting roller 2 having the significantly reduced diameter dM.

In the method shown, the spacing between two adjacent tracks of glue is s=4 mm, the width of tracks 3 of glue is b=8 mm, and the segment length AL=50 to 280 mm. In the case of these exemplary size ratios, the diameter of the cutting roller can be reduced to dM=64 mm, whereby this diameter was DM=90 mm before the solution according to the invention was found. Accordingly, it was possible to achieve a reduction in the cutting roller diameter by approximately 29%. Within the framework of the present invention, cutting roller diameters and circumferences are implemented, which obey the inequality p dM £0.9 ALmax, preferably p dM £0.75 ALmax, whereby ALmax represents the maximum segment length AL that is to be cut in the window glue-in station.

The acceleration or delay of cutting roller 2 in the method according to the invention takes place in such a manner that the cutting edge of cutting blade 8 performs a synchronous or pulling cut. If the segment length AL is greater than the circumference of cutting roller 2, its angular velocity after cutting is delayed, and accelerated back to a circumferential velocity that corresponds to the web velocity vB or lies above it, in timely manner before the next cut. If the segment length AL is less than the circumference of the cutting roller 2, it is accelerated after the cut, and delayed back to a circumference velocity that corresponds to the web velocity vB or lies slightly above it, in timely manner before the next cut.

In the case of the embodiment shown, the cutting roller 2 has a single cutting blade 8. In order to prevent the acceleration and delay forces required according to the invention from becoming too great, cutting roller 2 can be provided with several cutting blades on its circumference. This makes it possible to control cutting roller 2 with lesser accelerations or delays than those that occur in the case of only a single cutting blade on the circumference of cutting roller 2. In this connection, a disposition of several cutting blades at uniform angular distances over the circumference of cutting roller 2 is particularly suitable.

Accordingly, while only a few embodiments of the present invention have been shown and described, it is obvious that many changes and modifications may be made thereunto without departing from the spirit and scope of the invention.

Reference Symbol List

1 device

2 cutting roller

3 track of glue

4 deflection roller

5 glue application roller

6 transport roller

7 suction transport device

8 cutting blade

9 counter-cutting element

10 suction roller

11 suction channel

vB web velocity

w angular velocity

B window material web

BB envelope material web

s spacing between tracks of glue

b width of the track of glue

AL segment length dM diameter of the cutting roller according to the invention

DM diameter of the cutting roller according to the state of the art

R running direction of the envelope material web

1. Method for cutting a material web (B) into segments (A) having a predetermined segment length (AL), comprising:
moving the web at a web velocity (vB),
adapting an angular velocity of a cutting roller to the web velocity for cutting the material web (B), said angular velocity and web velocity adapted for being accelerated or delayed between two consecutive cuts; and
cutting the material web (B) with the cutting roller along predetermined cut progressions that lie between tracks (3) of ancillary substance that are raised relative to a plane of the material web (B), in a direction of the cutting roller (2).

2. Method according to claim 1, wherein the tracks of ancillary substance are tracks of glue.

3. Method according to claim 1, wherein the method is performed in a window glue-in station of an envelope production machine, and wherein the material web (B) is a window material web.

4. Method according to claim 1, wherein the method is performed in a separation insert station of an envelope production machine, and wherein the material web (B) is a separation insert material web.

5. Method according to claim 1, wherein the method is performed in an adhesive cover strip station of an envelope production machine, and wherein the material web is an adhesive cover strip material web.

6. Device for cutting a material web (B) into segments (A) having a predetermined segment length (AL), the web moving at a web velocity (vB), comprising:
a cutting roller (2) for cutting the material web, the roller having an angular velocity (w) that can be adapted to the web velocity (vB), and which can be accelerated or delayed between two consecutive cuts, wherein several cutting blades are disposed on a circumference of the cutting roller (2).

7. Device according to claim 6, wherein the cutting blades are disposed uniformly distributed over the circumference of the cutting roller (2).
